(19) United States
(12) Patent Application Publication
(10) Pub. No.: US 2014/0091897 A1
(43) Pub. Date: Apr. 3, 2014

(54) Method and system for measuring emotional engagement in a computer-facilitated event

(71) Applicant: Net Power and Light, Inc., San Francisco, CA (US)

(72) Inventors: Tara Lemmey, San Francisco, CA (US); Stanislav Vonog, San Francisco, CA (US); Nikolay Surin, San Francisco, CA (US)

(73) Assignee: Net Power and Light, Inc., San Francisco, CA (US)

(21) Appl. No.: 13/815,909

(22) Filed: Mar. 15, 2013

Related U.S. Application Data
(60) Provisional application No. 61/622,308, filed on Apr. 10, 2012.

(51) Int. Cl. G05B 1/01

(52) U.S. Cl. CPC G05B 1/01
USPC 340/3.1

(57) ABSTRACT

The present invention contemplates a variety of methods and systems for providing an event experience by adjusting contents of an event based on emotional engagements of a specific participant of the event. In one embodiment, the computer-implemented method includes, identifying at least one behavior of the specific participant at a specific physical venue, when the specific participant is participating in an event on the network; determining emotional engagement of the specific participant based on the at least one behavior of the specific participant; and adjusting a content or a content flow of the event in substantial real-time based on the emotional engagement of the specific participant.

### CROSS REFERENCE

This application claims the benefit of U.S. Provisional Patent Application Ser. No. 61/622,308 filed on Apr. 10, 2012, and the subject matter thereof is incorporated herein by reference in its entirety.

### FIELD OF INVENTION

The present disclosure generally relates to a system providing a computer-facilitated event, and in particular to a system capable of determining emotional engagements of participants and adjusting contents of the computer-facilitated event accordingly.

### BACKGROUND

Facilitating an event or a game to one or more participant(s) via a computer server is well known. For example, a computer server may host games locally and facilitate participants to access games remotely from the participants' devices. Remote participants can watch or play the games hosted by the server. However, the remote participants have little influence on contents of the event or the game being rendered by the computer server.

It would be advantageous to provide method and system for increasing the enjoyment and interaction of a computer-facilitated event.

### SUMMARY

The present disclosure includes a variety of methods and systems for providing an event experience by adjusting the contents of an event based on emotional engagements of a specific participant of the event. The event can be facilitated to the specific participant remotely by an experience platform via a network. When the specific participant joins the event from a specific physical venue, the experience platform can track behavior of the specific participant. In some embodiments, the behavior of the specific participant may be captured by built-in sensors of one or more computing devices and/or one or more optional sensors predisposed at the specific physical venue. Based on the captured behavior of the specific participant, the experience platform can determine emotional engagement of the specific participant. In response to the emotional engagement of the specific participant, the contents or content flow of the event can be adjusted to suit the specific participant's emotional or perceived emotional state.

In some embodiments, the one or more optional sensors are coupled to the one or more computing devices at the specific physical venue via wired or wireless connections. The built-in and optional sensors at the specific physical venue may include any suitable devices capable of capturing the specific participant's video, audio, gesture, heart rate, breath rate, temperature, pressure level, and/or sweat pattern.

In some embodiments, the experience platform may also collect surroundings data related to the specific physical venue, which include ambient parameters (e.g., room temperature, size, brightness and humidity), location, local time and weather condition at the specific physical venue. The emotional engagements of the specific participant can be determined by analyzing captured behaviors of the specific participant together with the data related to the specific physical venue.

In some embodiments, emotional engagements of the specific participant can be determined by analyzing the specific participant's virtual behaviors on the experience platform. For example, the specific participant may actively engage with other participants of the event. Virtual behaviors of the specific participant can be identified by tracking text inputs and instructions from input devices (e.g., keyboard, mouse, touch pad or touch screen) at the specific physical venue. In some embodiments, captured virtual activities can be analyzed together with captured physical behaviors (e.g., laughing, cursing, clapping or smiling) to determine the specific participant's emotional engagements.

In some embodiments, emotional engagements can be determined by some emotional gestures from the specific participant. The emotional gestures may include kinetic aspect (e.g., acceleration, deceleration, velocity and direction) and other dimensions (e.g., sound, image and pressure). The experience platform can identify the emotional gestures from the specific participant by analyzing collected data from kinetic sensor(s) (e.g., gyroscope, accelerometer, 3D camera and motion sensor) together with data from non-kinetic sensor(s) (e.g., microphone, camera and pressure sensor).

In some embodiments, the experience platform may keep a behavior profile for the specific participant. The behavior profile of the specific participant may a predetermined profile based on a database of known behavior patterns or a profile dynamically normalized and expanded based on the specific participant's past behaviors by using machine learning algorithms.

In some embodiments, options are provided for the specific participant to define settings of the specific participant's behavior profile and adjust thresholds of behavior recognition functions facilitated by the experience platform. Contents of the event can be adjusted, at least partially, based on a setting defined by the specific participant.

In some embodiments, the experience platform may determine whether to change content flow or modify contents of the event based on one or more of a plurality of factors. The plurality of factors may include the specific participant's actual and virtual behaviors over a period of time, the specific participant's non-behavioral profiles (e.g., geographic and demographic data) and participant settings such as preferences.

In some embodiments, metrics of emotional engagement of the specific participant can be calculated from the specific participant's actual and virtual behaviors by using a mathematical model. In some embodiments, metrics of emotional engagement may be determined based on a particular combination of identified emotional engagements over a period of time.

### BRIEF DESCRIPTION OF DRAWINGS

These and other objects, features and characteristics of the present disclosure will become more apparent to those skilled in the art from a study of the following detailed description in conjunction with the appended claims and drawings, all of which form a part of this specification. In the drawings:

FIG. 1 illustrates an event experience system according to one embodiment of the present disclosure.

FIG. 2 illustrates a schematic block diagram of a cloud-based experience platform according to another embodiment of the present disclosure.

FIG. 3 illustrates a sample process 300 for detecting and responding to a specific participant's emotional engagement, in accordance with yet another embodiment of the present disclosure

FIG. 4 shows an example representation of sentiment index according to one embodiment of the present invention.

FIG. 5 shows an example sporting event with participants at a physical venue.

FIG. 6 shows an example of a sporting event with participants at both a physical venue and at remote locations.

FIG. 7 shows an example diagram of a device, according to one embodiment.

FIG. 8 shows an example of a distributed system 500 according to one embodiment.

FIG. 9 shows a touch-screen device being utilized for an interactive event including a sporting event.

FIG. 10 shows a touch-screen device and large-screen television being utilized remotely from a sporting event.

FIG. 11 illustrates a system incorporated into an interactive game event according to one embodiment.

The drawings have not necessarily been drawn to scale. For example, the dimensions of some of the elements in the figures may be expanded or reduced to help improve the understanding of the embodiments of the present disclosure. Similarly, some components and/or operations may be separated into different blocks or combined into a single block for the purposes of discussion of some of the embodiments of the present disclosure. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present disclosure generally relates to methods and systems for providing an event experience. More specifically, various embodiments of the present invention relate to systems and methods for measuring emotional engagements of a specific participant in a computer-facilitated event and adjusting contents of the event accordingly. Traditionally, participants of an event (e.g., an online game) on a network can take part in the event via TV channels or the Internet. However, contents of the event are largely disconnected with reactions of the participants. For example, regardless whether a specific participant feels bored or excited about the event, contents delivered to the specific participant remain the same. In contrast, various embodiments of the present disclosure provide an experience platform that can adjust contents of the event based on emotional engagements of a specific participant.

While examples described herein refer to an event experience system, the descriptions should not be taken as limiting the scope of the present discloser. Various alternative, modifications and equivalents will be apparent to those skilled in the art without varying from the spirit of the invention. For example, methods for providing an event experience may be implemented in any computing system organizing live data stream. For another example, the event experience system may include multiple computer systems spanning multiple locations, or reside in a cloud.

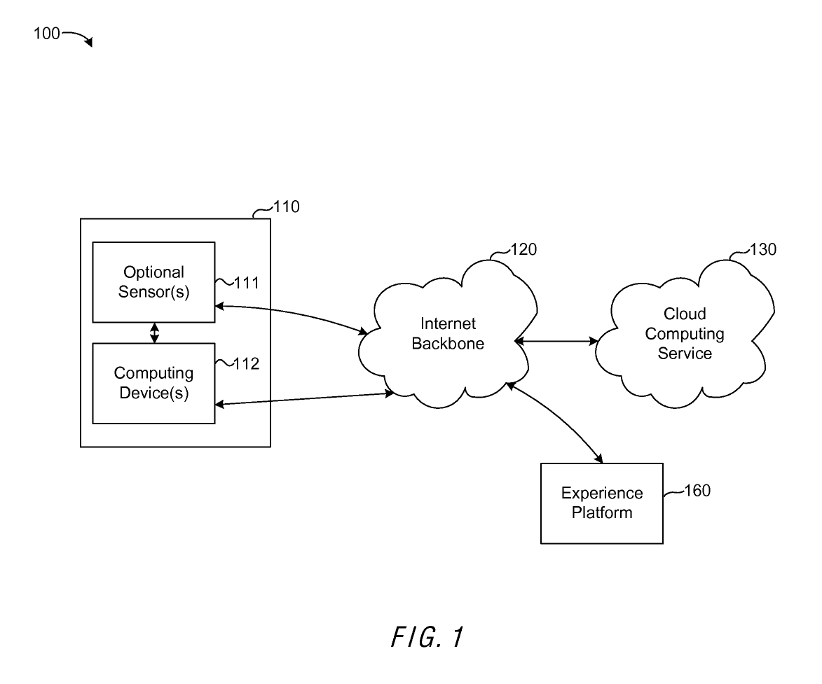

FIG. 1 illustrates an event experience system 100 suitable for facilitating an event according to one embodiment of the present disclosure. The system may include an experience platform 160, and a remote physical venue 110. The experience platform 160 can facilitate an event, for example, but not limited to, a movie, game, concert, TV show, sports event etc. The remote physical venue 110 may include one or more computing devices 112, such as an iPad®, iPhone®, Android® device, tablet device, desktop computer, netbook, laptop computer, personal digital assistant (PDA), portable computer, mobile phone, game console, media player, server, etc., one or more optional sensors 111, and an internet connection coupling the one or more smart devices to a cloud computing service 130. Each of the computing devices may have at least one built-in camera. The one or more optional sensors 111 may be coupled to the one or more computing devices 112 via wired or wireless connections. The one or more computing devices 112 and optional sensors 111 are configured to capture behavior of a specific participant at the remote physical venue 110 and then transmit captured live stream signals to the experience platform 160. Based on captured behavior of the specific participant, the experience platform 160 can determine metrics of emotional engagement of the specific participant at the remote physical venue 110 and adjust the contents of the event accordingly.

Behavior of a specific participant at the remote physical venue 110 can be captured by one or more sensor(s) at the physical venue 110. The one or more sensors may be built-in sensors with the computing devices 112 or optional sensors 111 that are separable from the computing devices 112. The one or more sensors may include any suitable devices capable of capturing the specific participant's video, audio, gesture, heart rate, breath rate, temperature, pressure level, and/or sweat pattern. For example, the one or more sensors may include, but are not limited to, a 2D or 3D camera, accelerometer, gyroscope, heart-rate sensor, blood oxygen-level sensor, temperature sensor, eye movement sensor, breath-rate sensor, proximity sensor, ambient light sensor, digital compass, gyroscope, GPS receiver, or magnetometer.

Captured behavior of the specific participant may also include text input and instruction from input devices at the physical venue 110, such as keyboard, mouse, touch pad or touch screen. The specific participant's behavior can be tracked and captured in substantial real-time by the one or more sensors and the input devices at the physical venue 110. The captured behavior data can be analyzed and used to determine emotional engagement of the specific participant. Based on the determined emotional engagement of the specific participant, the experience platform 160 may alter contents of the event to bring an improved experience for the specific participant.

For example, a specific participant at a specific physical venue is playing a video game on the experience platform 160. The physiological state (e.g., facial expression or heart rate) of the specific participant may be detected and collected by sensor(s) at the specific physical venue. The experience platform 160 may decrease the difficulty level of the video game if the collected behavior data (e.g., facial expression and/or heart rate) indicate that the specific participant is frustrated. On the other hand, artificial intelligence routines and/or background music may be adjusted if the collected behavior data (e.g., by tracing the specific participant's eye movement) indicate that the specific participant is bored or distracted.

In some embodiments, the emotional engagement of a specific participant can be assessed by a metric according to a predefined mathematical model. Depending on the metric of emotional engagement, contents of an event can be adjusted to match an emotional status of the specific participant. The contents of the event may be adjusted, for example, by changing one or more of an audio volume, an audio sequence, a video sequence, a difficult level, a sequence of media presentations, or an artificial intelligence setting. In some embodiments, the contents of the event are adjusted at least partially based a setting pre-determined by the specific participant.

Depending on metrics of emotional engagement of a specific participant, new contents, such as an advertisement suitable for an emotional status of the specific participant, can be added to the event. For example, a specific participant at a specific participant is watching a live game facilitated by the experience platform 160. If the collected behavior data indicate that the specific participant is excited, sweaty or thirsty, the experience platform 160 may present the specific participant an advertisement on cold beers or other beverages.

In some embodiments; the collected behavior data of a specific participant at a specific physical venue may include data collected by two or more disparate sensors disposed at the specific physical venue. The experience platform 160 can analyze the collected data from the two or more disparate sensors to determine some emotional gestures from the specific participant. The emotional engagement of a specific participant may be assessed by recognizing one or more emotional gestures of the specific participant. For example, the experience platform 160 may recognize the specific participant's waving hands as an emotional expression of excitement. An emotional gesture may include kinetic aspect (e.g., acceleration, deceleration, velocity and/or direction of an emotional gesture) and other dimensions such as sound, image, pressure, etc. To recognize the emotional gesture, the experience platform 160 may analyze the kinetic profile collected by sensors such as gyroscope, accelerometer, 3D camera, motion sensor etc., together with data from non-kinetic sensor(s) such as a microphone, camera, or pressure sensor etc.

In some embodiments, the experience platform 160 may keep a behavior profile for a specific participant. The behavior profile of the specific participant may be preset according to a database of known behavior patterns. The behavior profile may be dynamically constructed, normalized or expanded according to machine-learning algorithms. For example, the specific participant's behavior patterns and habits can be analyzed over time and added to the behavior profile. Based on participants' behavior profiles, the experience platform 160 may recognize different emotional engagements associated with a specific action.

For example, a specific participant is playing a game on the experience platform 160. Behavior, such as staring at a display screen, may represent a specific participant being focused or paying attention to the playing content from the experience platform 160. On the other hand, another participant may stare at a display screen because of mind-wandering or unrelated thoughts.

In some embodiments, the experience platform 160 may provide options for a specific participant to define settings of the specific participant's behavior profile or adjust thresholds of behavior recognition functions provided to the specific participant. The experience platform 160 may also provide the specific participant a set of behavior recognition functions with predefined thresholds, based on the specific participant's physical characteristics, such as height, gender, etc. Contents facilitated by the experience platform 160 can be adjusted, at least partially, based on a setting predefined by the specific participant. The specific participant may choose to disable the behavior recognition functions facilitated by the experience platform 160.

In some embodiments, the experience platform 160 may also collect surroundings data related to the specific physical venue 110. The data may include ambient parameters (e.g., room temperature, size, brightness and humidity), location, local time and weather condition at the specific physical venue 110. The experience platform 160 may determine emotional engagements of the specific participant by analyzing captured behavior of the specific participant together with the collected data related to the specific physical venue 110.

In some embodiments, the experience platform 160 may determine emotional engagements of a specific participant by also analyzing the specific participant's virtual behavior on the experience platform 160. For example, when excited, the specific participant may throw an animated object (e.g., a tomato) at display screens of other participants of an event. The specific participant may also select virtual gesture and/or actions (e.g., clapping, cheering, jeering and booing) facilitated by the experience platform 160 to express certain emotional expressions. The specific participant's virtual activities during an event can be tracked and captured in substantial real-time by input devices at the physical venue 110. The captured virtual activities can be combined with captured physical behavior (e.g., laughing, cursing, clapping, smiling) to determine the specific participant's emotional engagement.

In some embodiments, metrics of emotional engagement of a specific participant may be calculated by analyzing the specific participant's actual and virtual behavior during an event facilitated by the experience platform 160. For example, if the specific participant actively interacts with other participants of the event, a high metric of emotional engagement may be determined. Based on the metric of emotional engagement, contents of the event can be adjusted in substantial real-time in response to the specific participant's emotional engagement.

Some embodiments may provide methods instantiated on an experience platform, a local computer and/or a portable device. In some implementations, methods may be distributed across local and remote devices in the cloud computing service.

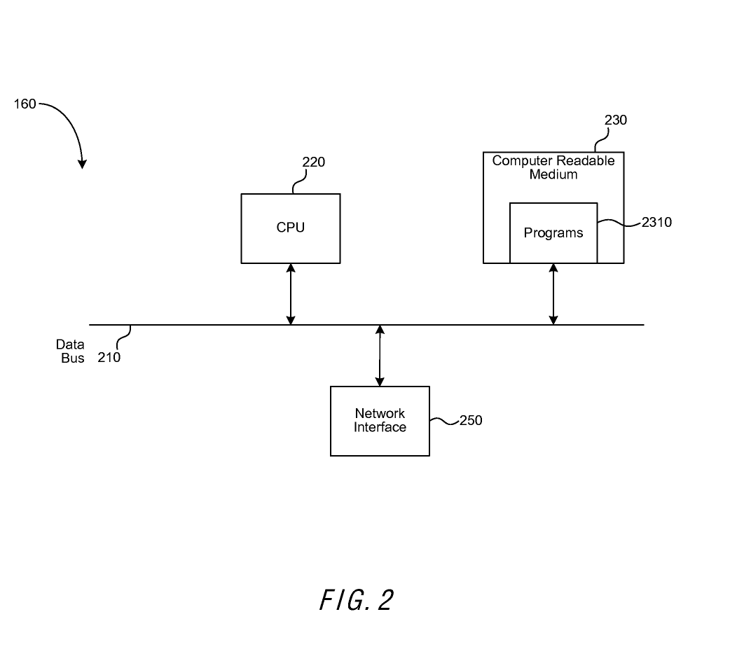

FIG. 2 illustrates a schematic block diagram of a cloud-based experience platform 160 according to another embodiment(s) of the present disclosure. The experience platform 160 may include at least one processor 220, one or more network interface(s) 250 and one or more computer readable medium(s) 230, all interconnected via one or more data bus(es) 210. The interconnections can be either wired or wireless connections. In FIG. 2, various components are omitted for illustrative simplicity. The experience platform 160 is intended to illustrate a device on which any other components described in this specification (e.g., any of the components depicted in FIG. 1) can be implemented.

The experience platform 160 may take a variety of physical forms. By way of examples, the experience platform 160 may be a desktop computer, a laptop computer, a personal digital assistant (PDA), a portable computer, a tablet PC, a wearable computer, an interactive kiosk, a mobile phone, a server, a mainframe computer, a mesh-connected computer, a single-board computer (SBC) (e.g., a BeagleBoard, a PC-on-a-stick, a Cubieboard, a CuBox, a Gooseberry, a Hawkboard, a Mbed, a OmapZoom, a OrigenBoard, a Pandaboard, a Pandora, a Rascal, a Raspberry Pi, a SheevaPlug, a Trim-Slice), an embedded computer system, or a combination of two or more of these. Where appropriate, the experience platform 160 may include one or more experience platform(s) 160, be unitary or distributed, span multiple locations, span multiple machines, or reside in a cloud, which may include one or more cloud components in one or more networks. Where appropriate, one or more experience plafform(s) 160 may perform without substantial spatial or temporal limitation one or more steps of one or more methods described or illustrated herein. As an example and not by way of limitation, one or more experience platform(s) 160 may perform in real time or in batch mode one or more steps of one or more methods described or illustrated herein. One or more experience platform 160(s) may perform at different times or at different locations one or more steps of one or more methods described or illustrated herein, where appropriate.

The experience platform 160 preferably may include an operating system such as, but not, limited to, Windows®, Linux® or UNIX®. The operating system may include a file management system, which organizes and keeps track of files. In some embodiments, a separate file management system may be provided. The separate file management can interact smoothly with the operating system and provide enhanced and/or more features, such as improved backup procedures and/or stricter file protection.

The at least one processor 220 may be any suitable processor. The type of the at least one processor 220 may comprise one or more from a group comprising a central processing unit (CPU), a microprocessor, a graphics processing unit (GPU), a physics processing unit (PPU), a digital signal processor, a network processor, a front end processor, a data processor, a word processor and an audio processor.

The one or more data bus(es) 210 is configured to couple components of the experience platform 160 to each other. As an example and not by way of limitation, the one or more data bus(es) 210 may include a graphics bus (e.g., an Accelerated Graphics Port (AGP)), an Enhanced Industry Standard Architecture (EISA) bus, a front-side bus (FSB), a HyperTransport (HT) interconnect, an Industry Standard Architecture (ISA) bus, an Infiniband interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Although the present disclosure describes and illustrates a particular bus, this disclosure contemplates any suitable bus or interconnects.

The one or more network interface(s) 250 may include one or more of a modem or network interface. It will be appreciated that a modem or network interface(s) can be considered to be part of the experience platform 160. The interface can include an analog modem, an asymmetric digital subscribe line (ADSL) modem, a cable modem, a doubleway satellite modem, a power line modem, a token ring interface, a Cambridge ring interface, a satellite transmission interface or any suitable interface for coupling a computer system to other computer systems. The interface can include one or more input and/or output devices. The I/O devices can include, by way of example but not limitation, a keyboard, a mouse or other pointing device, disk drives, printers, a scanner, a touch screen, a tablet screen, and other input and/or output devices, including a display device. The display device can include, by way of example but not limitation, a cathode ray tube (CRT) display, a liquid crystal display (LCD), a 3D display, or some other applicable known or convenient display device. For simplicity, it is assumed that controllers of any devices not depicted in the example of FIG. 2 reside in the interface.

The computer readable medium 230 may include any medium device that is accessible by the processor 220. As an example and not by way of limitation, the computer readable medium 230 may include volatile memory (e.g., a random access memory (RAM), a dynamic RAM (DRAM), and/or a static RAM (SRAM)) and non-volatile memory (e.g., a flash memory, a read-only memory (ROM), a programmable ROM (PROM), an erasable programmable ROM (EPROM), and/or an electrically erasable programmable ROM (EEPROM)). When appropriate, the volatile memory and/or non-volatile memory may be single-ported or multiple-ported memory. This disclosure contemplates any suitable memory. In some embodiments, the computer readable medium 230 may include a semiconductor-based or other integrated circuit (IC) (e.g., a field-programmable gate array (FPGA) or an application-specific IC (ASIC)), a hard disk, an HDD, a hybrid hard drive (HHD), an optical disc (e.g., a CD-ROM, or a digital versatile disk (DVD)), an optical disc drive (ODD), a magneto-optical disc, a magneto-optical drive, a floppy disk, a floppy disk drive (FDD), a magnetic tape, a holographic storage medium, a solid-state drive (SSD), a secure digital (SD) card, a SD drive, or another suitable computer-readable storage medium or a combination of two or more of these, where appropriate. The computer readable medium 230 may be volatile, non-volatile, or a combination of volatile and non-volatile, where appropriate.

Programs 2310 may be stored on the one or more computer readable medium(s) 230. As an example, but not by way of limitation, the experience platform 160 may load the programs 2310 to an appropriate location on the one or more compute readable medium(s) 230 for execution. The programs 2310, when executed, may cause the experience platform 160 to perform one or more operations or one or more methods described or illustrated herein. In some implementations, the operations may include, but are not limited to, identifying at least one behavior of a specific participant at a specific physical venue, when the specific participant is participating in an event on a network; determining emotional engagement of the specific participant based on the at least one behavior of the specific participant; and adjusting a content or a content flow of the event in substantial real-time based on the emotional engagement of the specific participant.

As will be appreciated by one of ordinary skill in the art, the operations may be instantiated locally (e.g. on a local computer or a portable device) and may be distributed across a system including a portable device and one or more other computing devices. For example, it may be determined that the available computing power of the portable device is insufficient or that additional computer power is needed, and may offload certain aspects of the operations to the cloud.

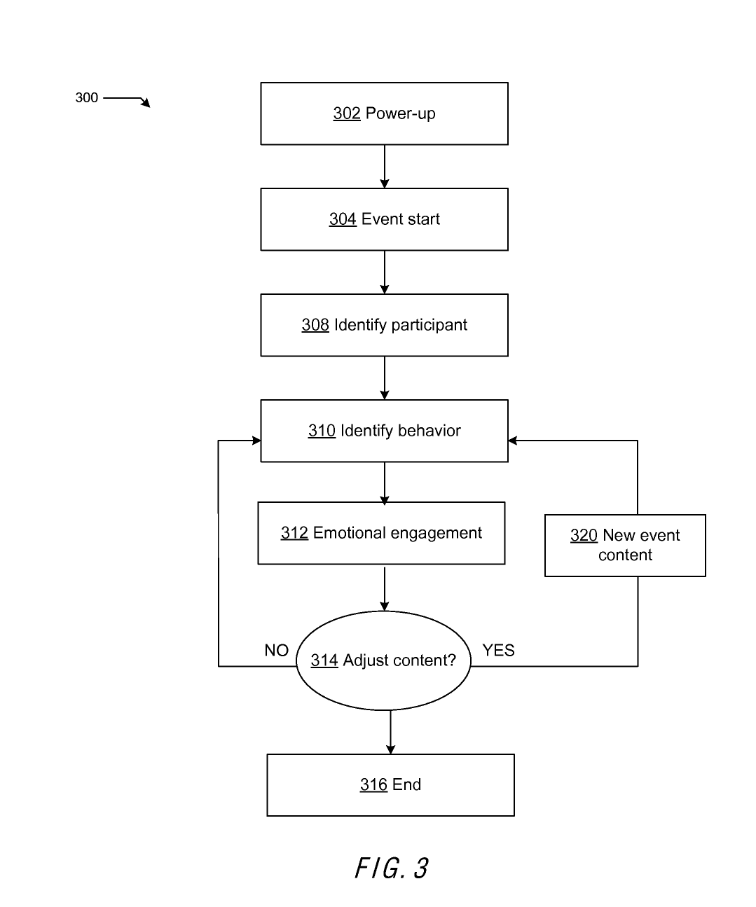

FIG. 3 illustrates a sample process 300 for detecting and responding to a specific participant's emotional engagement, in accordance with yet another embodiment of the present disclosure. At step 302, the sample process 300 starts at a power-up cycle for one or more computing devices at a specific remote physical venue and an experience platform. Optional one or more sensors at the specific physical venue may also start at the power-up cycle. Built-in sensors of the one or more computing devices and the optional one or more sensors can be pre-positioned to capture activities or reactions of a specific participant at the specific physical venue.

At step 304, an event is facilitated by the experience platform. A specific participant at the specific remote physical venue can log onto the experience platform and join the event remotely. The experience platform may identify the specific participant by the participant's login profile, at step 308. In some embodiments, the experience platform may identify the specific participant by analyzing collected data from the built-in sensors of the one or more computing devices and the optional one or more sensors. The collected data may include physical and virtual activities or reactions of the specific participant at the specific physical venue. In some embodiments, ambient parameters, location, local time and weather condition at the specific physical venue may also be collected and analyzed.

At 310, the experience platform may determine the specific participant's behavior based on the collected data related to the specific participant and/or the specific physical venue. In some embodiments, the specific participant's behavior is determined based on a database of known behavior patterns. In some embodiments, the specific participant's behavior is determined based on a participant profile that is dynamically constructed and expanded according to machine-learning algorithms.

At step 312, the experience platform may determine emotional engagement of the specific participant based on the specific participant's behavior. In some embodiments, metrics of emotional engagement can be calculated by using a computer algorithm. At step 314, the experience platform determines whether the content of the event needs to be adjusted according to the specific participant's emotional engagement. For example, if there is a mismatch between contents being delivered to the specific participant and the emotional engagement of the specific participant, the contents can be adjusted in response to or based on the specific participant's emotional engagement.

At step 320, if the experience platform determines the contents of the event needs to be adjusted, new content or event flow can be added or replaced scheduled content of the event to better suit the specific participant's emotional or perceived emotional state. The process 300 continues to identify the specific participant's behavior at step 310 after the content of the event is adjusted or if the experience platform determines no change is necessary. The process 300 ends at step 316 if the event is complete.

In some embodiments, metrics of a specific participant's emotional engagement are determined based on identified behavior of the specific participant and the specific participant's behavior profile and other profile data. The thresholds to identify the specific participant's behavior may be predetermined or adjusted at step 320. As the event progresses, the specific participant's behavior can be continuously captured and the emotional engagement of the specific participant can be determined at steps 310 and 312. Based on the specific participant's emotional engagement and the event content being delivered, the experience platform can determine whether to change content flow at step 314, as discussed above. The content delivered to the specific participant can be matched to the identified emotional state of the specific participant in substantial real-time.

In some embodiments, the experience platform determines whether to change content flow or modify content based on a specific participant's behaviors over a period of time, opposed to a single behavior alone. The decision at step 314 may be further influenced by the specific participant's other profiles (e.g., geographic and demographic data) and participant settings such as preferences. In some embodiments, metrics of emotional engagement may be determined based on a particular combination of identified emotional engagement by using a mathematical model.

Certain embodiments of the invention facilitate the provision of a higher quality experience for people participating in an event. In general, people have a higher quality experience at an event when they are emotionally engaged. One problem in facilitating engagement is simply determining how to sense or measure the emotional engagement of the people participating in the event, and in turn provide a more emotionally engaging, and therefore higher quality experience. There are a few commercially available systems that purport to measure human emotion. For example using augmented video analysis (nViso) or skin conductance (Q Sensor by Affectiva). The complexity and subjective nature of human emotion makes it very difficult to gauge using one method alone.

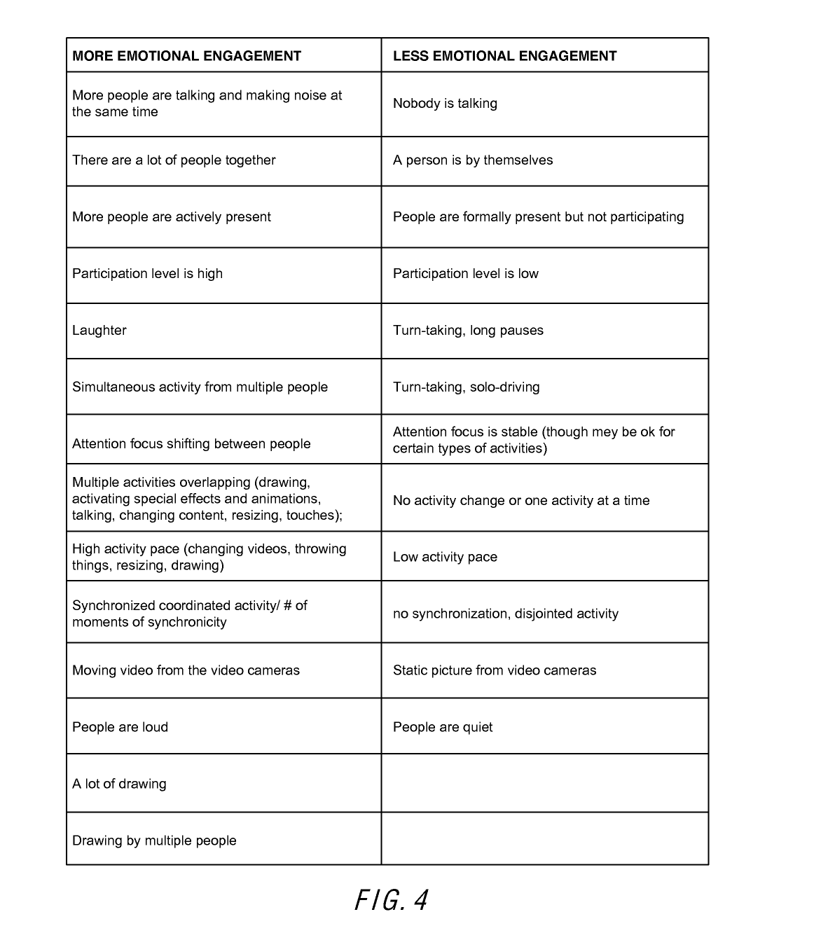

In order to provide this more emotionally engaging experience, according to one embodiment, the system can perform any combination of the following: 1) begins with a sentiment index (See FIG. 4) that contains a plurality of observations with associated emotional engagement determinations, 2) observes the participants of an event, 3) identifies appropriate variables based on observations, 4) assigns a quantified score to the appropriate variables based on a comparison of the observation to the sentiment index, 5) determines the emotional engagement of the participants of the event, 6) alters the content and/or presentation of the event, 7) updates the sentiment index, and 8) repeats the cycle.

The Sentiment Index

FIG. 4 shows an example representation of sentiment index according to one embodiment of the present invention. Here a number of predefined observations can be organized into two classifications, “more emotionally engaging” and “less emotionally engaging.” It should be noted that this classifications system need not be binary. For example, according to one embodiment, the sentiment index may have ten or more levels of emotional engagement. Under each classification is a list of exemplary observations associated with its respective classification.

The examples are included merely to illustrate that any type of act, omission or combination of the two on the part of the participants may indicate their relative level of emotional engagement. For example a signal observation by the system that there is simultaneous activity from multiple people may indicate that the participants are experiencing a high level of emotional engagement. Conversely, a signal observation by the system that multiple participants are stagnant and quiet may indicate that the participants are experiencing a low level of emotional engagement. It should be understood that, these determinations are not absolute and may depend on context. For example, an observation of many participants shouting at a high volume may indicate a high level of emotional engagement when observed in the context of a sporting event. Conversely, a similar observation may indicate a low level of observation when observed in the context of a movie played at a theater.

According to one embodiment, the system may determine a number of different sentiment indexes. For example sentiment indexes for individual participants, participant subgroups of an event, remote locations participating in the event, or for the event as a whole.

Observing Sentiment Signals

According to one embodiment, the system may observe and/or examine signals associated with or representative of participants. For example sensing the volume of the participants' voices via a microphone, or viewing the number of participants leaving the event via a camera. The system may also observe participants by receiving inputs from the participants. For example, the system may register an increased level and frequency of input on a touch screen device being used by a participant.

The system may observe participants in any number of different combinations. According to one embodiment, an emotional engagement module may 1) monitor one input or one sensor from a single device, 2) monitor multiple inputs and/or multiple sensors from a single device, 3) monitor one input or one sensor from multiple devices, or 4) monitor multiple inputs and/or multiple sensors from multiple devices. Although the emotional engagement module may monitor any number of inputs or sensors form any number of devices, it will be understood that the application of hybrid approach of monitoring multiple inputs and sensors form multiple devices is likely to result in more accurate determinations on emotional engagement.

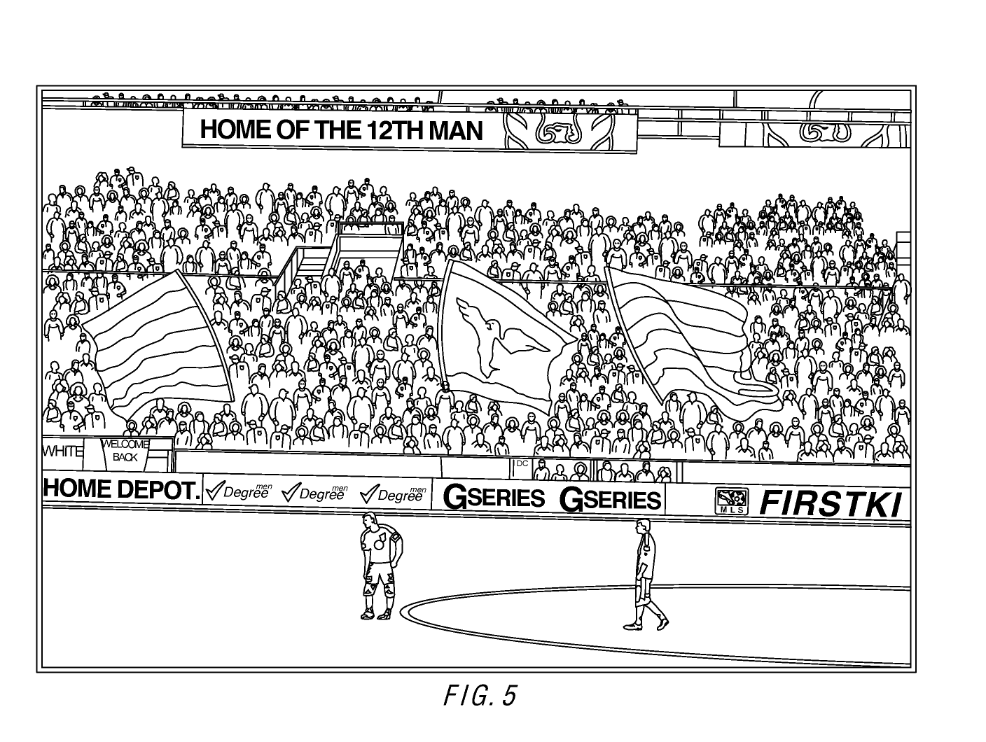

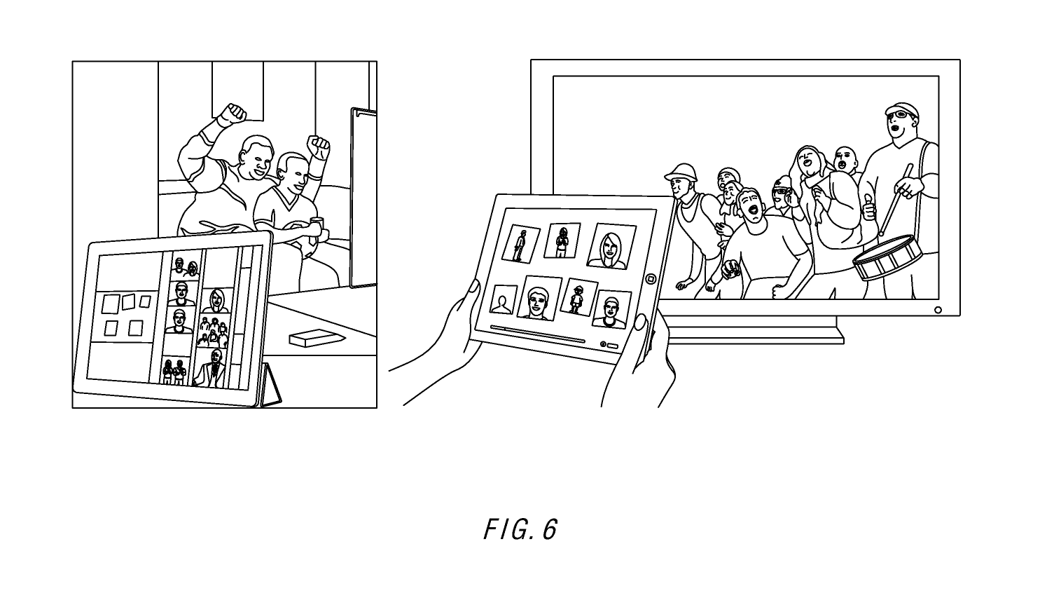

FIG. 5 shows an example sporting event with participants at a physical venue. According to one embodiment, the emotional engagement module may monitor inputs and/or sensors from mobile devices associate with a number of different participants at the live venue. Similarly, FIG. 6 shows an example of a sporting event with participants at both a physical venue and at remote locations. According to one embodiment, the emotional engagement module may monitor the sensory data in the form of live AV streams from remote participants as well as input from remote participants such as resizing an object displayed on a touch screen device associated with the AV stream from a participant at another remote location.

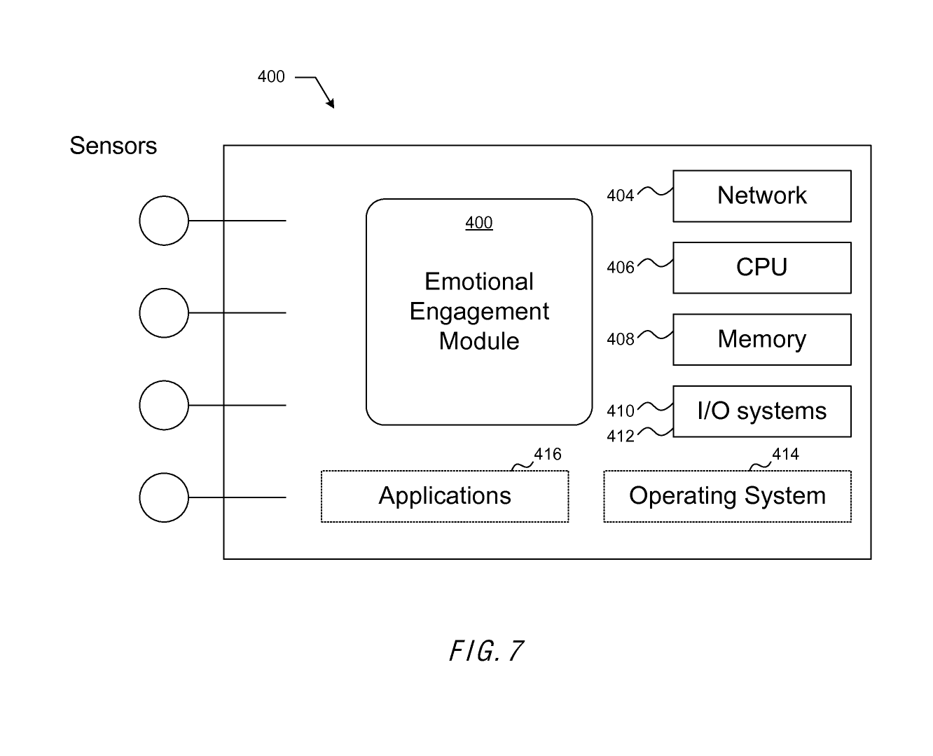

FIG. 7 shows an example diagram of a device 400, according to one embodiment. The device 400 may contain an emotional engagement module 402, a network interface 404, a central processing unit 406, memory 408, various input and/or sensor devices 410, an output device 412, an operating system 414 and various applications 416. The hardware and software associated with the emotional engagement module 402 may either be located at the device end, on a remote computing device, on a plurality of remote computing devices through the use of a cloud computing system, or in any combination of the like.

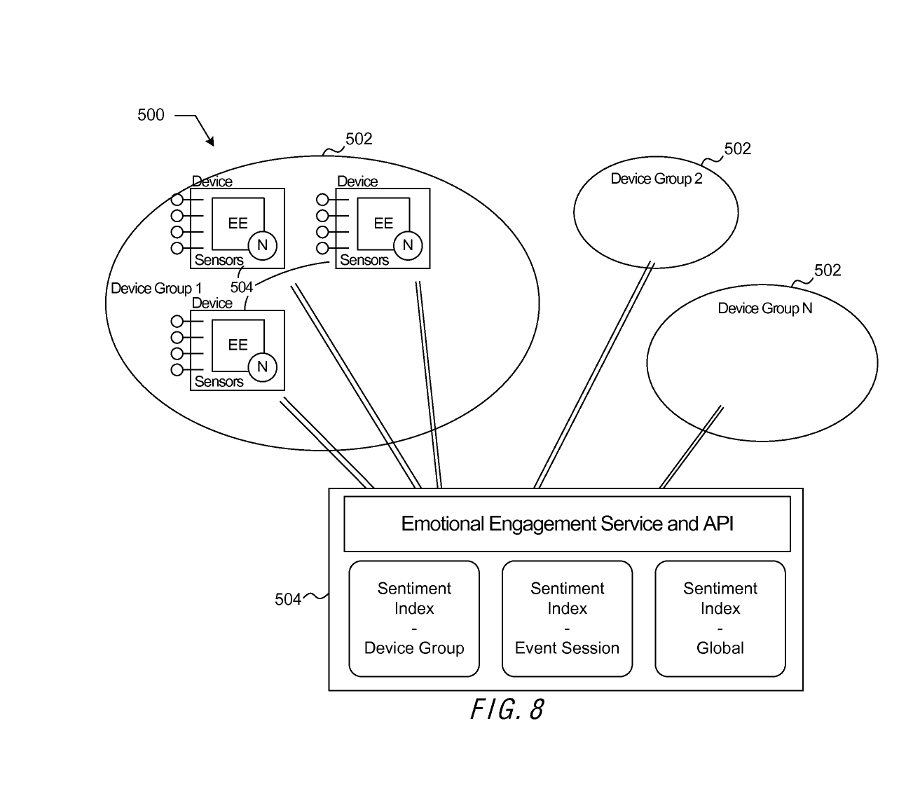

FIG. 8 shows an example of a distributed system 500 according to one embodiment. Here an event has multiple local device groups 502 with a number of devices 504 associated with each local device group 502. The system 500 coordinates the experiences of each local device group 502 through a central emotional engagement service 504.

Altering the Content and or Presentation of the Event

The system according to one embodiment of the present invention may alter the content and/or presentation of an event in a number of different ways.

In response to the determined level of emotional engagement, the system may either alter the content and/or presentation automatically or it may provide a human producer entity with data associated with the level of emotional engagement along with tools needed to alter the content and/or presentation of the event. Additionally, the system may provide the producer with suggestions on how to alter the content and/or presentation of the event.

The following are some examples showing, according to one embodiment, how the system, or the human producer entity, by way of the system may alter the content and/or presentation of the event.

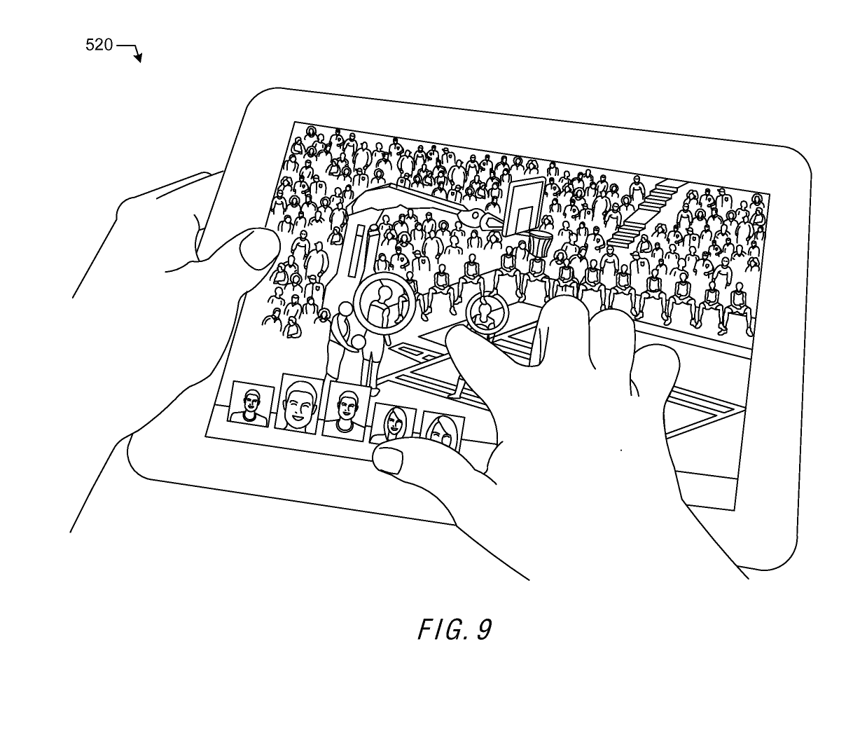

According to FIG. 9 the system in accordance with one embodiment may observe that a person participating in a sporting event from a remote location is carrying a touch-screen device 520 that is displaying a live video stream from the event. The system may also observe that the person participating in the sporting event is simultaneously carrying the touch-screen device 520 around with them as they walk while touching various interactive options, such as circling or zooming in on a particular participant at the physical venue of the sporting event, displayed on the touch-screen device 520. Recognizing these actions and inputs to indicate a heightened level of emotional engagement, the system may then automatically alter the content of the event by displaying a live video stream of other people participating in the sporting event, or providing an interactive option to further engage in the sporting event, such as a “cheer” button.

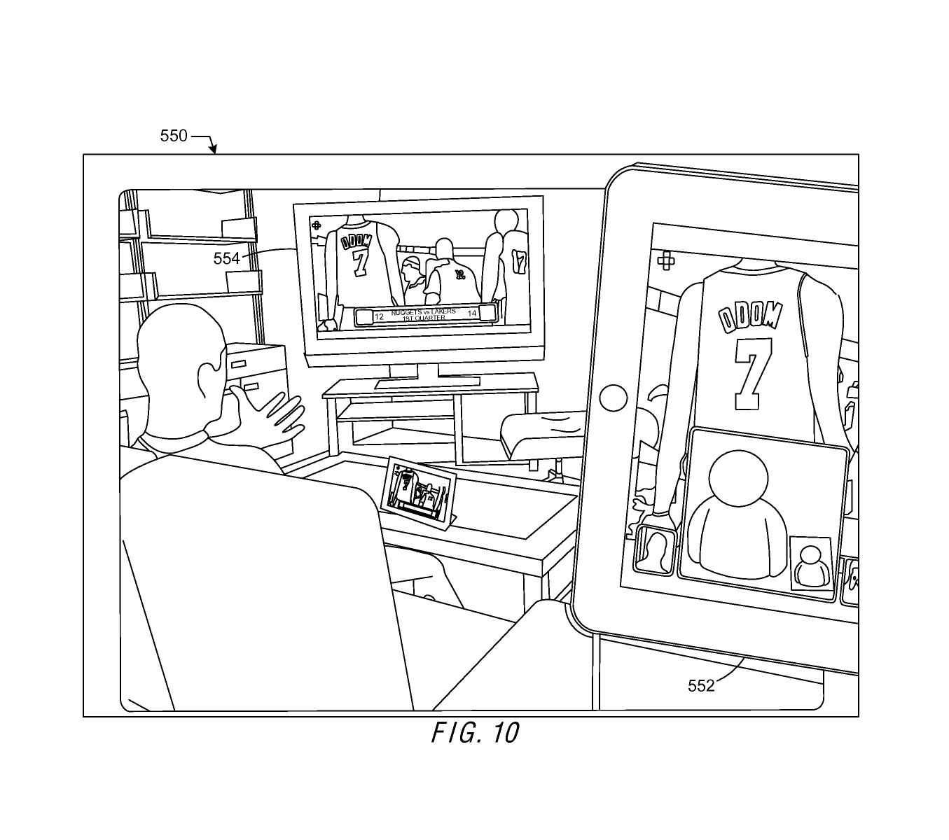

Similarly, according to FIG. 10 the system in accordance with one embodiment, may observe that a person participating in a sporting event from a remote location 550 is using a touch screen device 552 to simultaneously view the event via a live AV stream and talk with a friend about the sporting event via a live video AV stream. Recognizing these actions and inputs to indicate a heightened level of emotional engagement, the system may then provide the participant an option to view the live AV stream of the sporting event on the larger screen 554 of their television device.

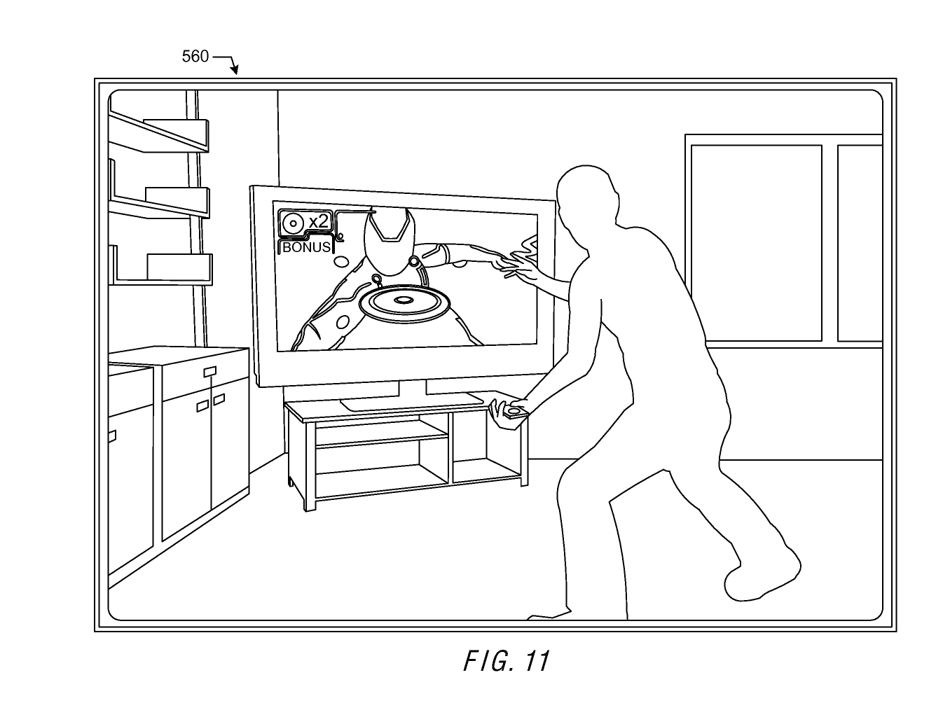

According to FIG. 11 a system 560 in accordance with one embodiment, may observe that a person playing an interactive game event using gestures to provide input to the interactive game event. The system 560 may also observe that the relatively slow gestures of the participant indicate a low level of emotional engagement. The system may then automatically increase the volume of sound output and/or display additional exciting graphics in order to heighten the emotional engagement of the participant.

As will be appreciated by one of ordinary skill in the art, the operations or methods may be instantiated locally (e.g., on one local computer system) and may be distributed across remote computer systems. For example, it may be determined that the available computing power of the local computer system is insufficient or that additional computing power is needed, and may offload certain aspects of the operations to the cloud.

While the computer-readable medium is shown in an embodiment to be a single medium, the term “computer-readable medium” should be taken to include single medium or multiple media (e.g., a centralized or distributed database, and/or associated caches and servers) that stores the one or more sets of instructions. The term “computer-readable medium” shall also be taken to include any medium that is capable of storing, encoding or carrying a set of instructions for execution by the computer and that cause the computer to perform any one or more of the methodologies of the presently disclosed technique and innovation.

Further examples of computer-readable medium, machine-readable storage medium, machine-readable medium or computer-readable (storage) medium include but are not limited to recordable type medium such as volatile and non-volatile memory devices, floppy and other removable disks, hard disk drives, optical disks, Digital Versatile Disks, among others and transmission type medium such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The computer may be, but is not limited to, a server computer, a client computer, a personal computer (PC), a tablet PC, a laptop computer, a set-top box (STB), a personal digital assistant (PDA), a cellular telephone, an iPhone®, an iPad®, a processor, a telephone, a web appliance, a network router, switch or bridge, or any machine capable of executing a set of instructions (sequential or otherwise) that specify actions to be taken by that machine.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In general, the routines executed to implement the embodiments of the disclosure may be implemented as part of an operating system or a specific application, component, program, object, module or sequence of instructions referred to as “programs.” The programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, various embodiments are capable of being distributed as a program product in a variety of forms, and that the disclosure applies equally regardless of the particular type of computer-readable medium used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but is not limited to.” As used herein, the terms “connected,” “coupled,” or any variant thereof, means any connection or coupling, either direct or indirect, between two or more elements; the coupling of connection between the elements can be physical, logical or a combination thereof. Additionally, the words “herein,” “above,” “below” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word, any of the items in the list, all of the items in the list and any combination of the items in the list.

The above detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks in a different order, and some processes or blocks may be deleted, moved, added, subdivided, combined and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples—alternative implementations may employ differing values or ranges.

The teaching of the disclosure provided herein can be applied to other systems and not necessarily to the system described above. Any patents and applications and other references noted above, including any that may be listed in accompanying filing papers, are incorporated herein by reference. Aspects of the disclosure can be modified if necessary to employ the systems, functions and concepts of the various references described above to provide yet further embodiments of the disclosure.

Any patents and applications and other references noted above, including any that may be listed in accompanying filing papers, are incorporated herein by reference. Aspects of the disclosure can be modified if necessary to employ the systems, functions, and concepts of the various references described above to provide yet further embodiments of the disclosure.

These and other changes can be made to the disclosure in light of the above Detailed Description. While the above description describes certain embodiments of the disclosure and describes the best mode contemplated, no matter how detailed the above appears in text, the teachings can be practiced in many ways. Details of the system may vary considerably in its implementation details while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally or logically, are understood to be implemented by computer programs or equivalent electrical circuits, microcode or the like. Furthermore, it has also proven convenient at times to refer to these arrangements of operations as modules, without loss of generality. The described operations and their associated modules may be embodied in software, firmware, hardware or any combinations thereof.

Any of the steps, operations or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of medium suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein.

What is claimed is:

1. A computer implemented method for providing an event experience on a network, the method comprising:
identifying at least one behavior of a specific participant at a specific physical venue, when the specific participant is participating in an event on the network;
determining emotional engagement of the specific participant based on the at least one behavior of the specific participant; and
adjusting a content or a content flow of the event in substantial real-time based on the emotional engagement of the specific participant.

2. The method as recited in claim 1, wherein the at least one behavior of the specific participant is captured by sensors disposed at the specific physical venue, the sensors including one or more of a 2D or 3D camera, accelerometer, gyroscope, heart-rate sensor, blood oxygen-level sensor, temperature sensor, eye movement sensor, breath-rate sensor, proximity sensor, ambient light sensor, digital compass, gyroscope, GPS receiver, and magnetometer.

3. The method as recited in claim 2, wherein the sensors include built-in sensors of one or more computing devices and/or one or more optional sensors pre-positioned at the specific physical venue, the one or more computing devices including one or more of an iPad®, iPhone®, Android® device, tablet device, desktop computer, netbook, laptop computer, personal digital assistant (PDA), portable computer, mobile phone, game console, media player, or server.

4. The method as recited in claim 3, wherein the one or more optional sensors is coupled to the one or more computing devices via wired or wireless connections.

5. The method as recited in claim 3, further comprising:
identifying at least one virtual behavior of the specific participant during the event via at least one input device of the one or more computing devices; the input device including keyboard, mouse, touch pad, and touch screen; and
determining the emotional engagement of the specific participant based on the at least one behavior and virtual behavior of the specific participant.

6. The method as recited in claim 5, further comprising:
calculating metrics of the emotional engagement of the specific participant based on the at least one behavior and virtual behavior of the specific participant by using a mathematical model; and
adjusting the content or the content flow of the event in substantial real-time based on at least a metric of emotional engagement of the specific participant.

7. The method as recited in claim 5, further comprising:
tracking surroundings data related to the specific physical venue, the surroundings data including ambient parameters, location, local time and weather condition at the specific physical venue, the ambient parameters including room temperature, size, brightness and humidity; and
determining the emotional engagement of the specific participant based on the at least one behavior and virtual behavior of the specific participant and the surroundings data related to the specific physical venue.

8. The method as recited in claim 7, further comprising:
identifying at least one emotional gesture of the specific participant by analyzing data collected by the sensors and the at least one input device; and
determining the emotional engagement of the specific participant at least partially based on the at least one emotional gesture of the specific participant.

9. The method as recited in claim 3, wherein the at least one behavior is identified by comparing the specific participant's activities with a behavior profile of the specific participant.

10. The method as recited in claim 9, wherein the behavior profile is a predetermined profile based on a database of known behavior patterns or a profile dynamically normalized and expanded based on the specific participant's past behaviors by using machine learning algorithms.

11. The method as recited in claim 10, further comprising:
providing options for the specific participant to define settings of the specific participant's behavior profile and adjust thresholds in identifying the at least one behavior.

12. The method as recited in claim 11, wherein the content or the content flow of the event is adjusted at least based on a setting defined by the specific participant.

13. The method as recited in claim 1, wherein the emotional engagement of the specific participant is determined by analyzing the at least one behavior of the specific participant over a period of time.

14. The method as recited in claim 1, wherein the content or the content flow of the event is adjusted to match an emotional status of the specific participant.

15. The method as recited in claim 1, wherein the content or the content flow of the event is adjusted to present an advertisement suitable for an emotional status of the specific participant.

16. The method as recited in claim 1, wherein the content or the content flow of the event is adjusted by changing one or more of an audio volume, an audio sequence, a video sequence, a difficult level, a sequence of media presentations, or an artificial intelligence setting.

17. The method as recited in claim 1, wherein the event is a movie, game, concert, TV show, sports event.

18. An experience platform, the platform comprising:
a network adapter configured to communicate with one or more computing devices of a specific participant at a specific physical venue via a network; and
a memory coupled to the network adapter and configured to store computer code corresponding to operations for providing an event experience on the network, the operations comprising:
identifying at least one behavior of the specific participant at the specific physical venue, when the specific participant is participating in an event on the network;
determining emotional engagement of the specific participant based on the at least one behavior of the specific participant; and
adjusting a content or a content flow of the event in substantial real-time based on the emotional engagement of the specific participant.

19. The experience platform as recited in claim 18, wherein the at least one behavior of the specific participant is captured by sensors disposed at the specific physical venue, the sensors including one or more of a 2D or 3D camera, accelerometer, gyroscope, heart-rate sensor, blood oxygen-level sensor, temperature sensor, eye movement sensor, breath-rate sensor, proximity sensor, ambient light sensor, digital compass, gyroscope, GPS receiver, and magnetometer.

20. The experience platform as recited in claim 19, wherein the sensors include built-in sensors of the one or more computing devices and/or one or more optional sensors pre-positioned at the specific physical venue, the one or more computing devices including one or more of an iPad®, iPhone®, Android® device, tablet device, desktop computer, netbook, laptop computer, personal digital assistant (PDA), portable computer, mobile phone, game console, media player, or server.

21. The experience platform as recited in claim 20, wherein the one or more optional sensors is coupled to the one or more computing devices via wired or wireless connections.

22. The experience platform as recited in claim 20, wherein the operations further comprises:
identifying at least one virtual behavior of the specific participant during the event via at least one input device of the one or more computing devices; the input device including keyboard, mouse, touch pad, and touch screen; and
determining the emotional engagement of the specific participant based on the at least one behavior and virtual behavior of the specific participant.

23. The experience platform as recited in claim 22, wherein the operations further comprises:
calculating metrics of the emotional engagement of the specific participant based on the at least one behavior and virtual behavior of the specific participant by using a mathematical model; and
adjusting the content or the content flow of the event in substantial real-time based on at least a metric of emotional engagement of the specific participant.

24. The experience platform as recited in claim 22, wherein the operations further comprises:
tracking surroundings data related to the specific physical venue, the surroundings data including ambient parameters, location, local time and weather condition at the specific physical venue, the ambient parameters including room temperature, size, brightness and humidity; and
determining the emotional engagement of the specific participant based on the at least one behavior and virtual behavior of the specific participant and the surroundings data related to the specific physical venue.

25. The experience platform as recited in claim 24, wherein the operations further comprises:
identifying at least one emotional gesture of the specific participant by analyzing data collected by the sensors and the at least one input device; and
determining the emotional engagement of the specific participant at least partially based on the at least one emotional gesture of the specific participant.

26. The experience platform as recited in claim 20, wherein the at least one behavior is identified by comparing the specific participant's activities with a behavior profile of the specific participant.

27. The experience platform as recited in claim 26, wherein the behavior profile is a predetermined profile based on a database of known behavior patterns or a profile dynamically normalized and expanded based on the specific participant's past behaviors by using machine learning algorithms.

28. The experience platform as recited in claim 27, wherein the operations further comprises:
providing options for the specific participant to define settings of the specific participant's behavior profile and adjust thresholds in identifying the at least one behavior.

29. The experience platform as recited in claim 28, wherein the content or the content flow of the event is adjusted at least based on a setting defined by the specific participant.

30. The experience platform as recited in claim 18, wherein the emotional engagement of the specific participant is determined by analyzing the at least one behavior of the specific participant over a period of time.

31. The experience platform as recited in claim 18, wherein the content or the content flow of the event is adjusted to match an emotional status of the specific participant.

32. The experience platform as recited in claim 18, wherein the content or the content flow of the event is adjusted to present an advertisement suitable for an emotional status of the specific participant.

33. The experience platform as recited in claim 18, wherein the content or the content flow of the event is adjusted by changing one or more of an audio volume, an audio sequence, a video sequence, a difficult level, a sequence of media presentations, or an artificial intelligence setting.

34. The experience platform as recited in claim 18, wherein the event is a movie, game, concert, TV show, sports event.

35. An apparatus for providing an event experience on a network, the apparatus comprising:
means for identifying at least one behavior of a specific participant at a specific physical venue, when the specific participant is participating in an event on the network;
means for determining emotional engagement of the specific participant based on the at least one behavior of the specific participant; and
means for adjusting a content or a content flow of the event in substantial real-time based on the emotional engagement of the specific participant.
